(19) United States
(12) Patent Application Publication
(10) Pub. No.: US 2014/0017377 A1
(43) Pub. Date: Jan. 16, 2014

(54) PROCESS TO OBTAIN BEVERAGE ENRICHED WITH FIBERS AND VITAMINS WITH ADDED FRUIT FLAVORS AND A BEVERAGE RESULTING FROM THIS PROCESS

(71) Applicant: Francisco Ruette, Sao Paulo (BR)

(72) Inventor: Francisco Ruette, Sao Paulo (BR)

(21) Appl. No.: 13/576,560

(22) PCT Filed: Mar. 30, 2011
(86) PCT No.: PCT/BR11/00086

§ 371 Date: Aug. 1, 2012

(51) Int. Cl. A23L 2/52

(52) U.S. Cl. CPC A23L 2/52
USPC 426/548; 426/590

(57) ABSTRACT

New process to obtain a beverage enriched with fibers and vitamins with added fruit flavors and a beverage from this process, in which is an innovative process having as result an innovative beverage that provides an improvement in the quality of life regarding the health of the intestinal tract, promoting the ingestion of soluble and non-soluble needed in the human organism preventing diseases, promoting hydration, moderating the blood glucose and the levels of lipid in the serum and contributing to appetite moderation, serving as a natural and diet food, being able to be used in normal and strict diets without side effects. Therefore being a functional beverage of a high aggregated value.

The present report has a detailed description of a new process to obtain beverage enriched with fibers and vitamins with added fruit flavors and also a beverage from this process, being an innovative process resulting in an innovative beverage providing improvement in the quality of life regarding the health of the intestinal tract, promoting the ingestion of soluble and non-soluble fibers necessary for the human body, preventing diseases, promoting hydration, moderating blood glucose and lipid levels in the serum; and contributing to appetite moderation, being a natural and diet food, with applications in normal and strict diets without any side effects. Thus being a functional beverage with a high aggregated value.

Water and fluids are vital to digestion, which consequently contributes to a good eating habit and quality of life. To have a good intestinal flow it is important to ingest around two liters of water a day and also foods containing soluble and non-soluble fibers, besides essential vitamins and minerals. Seeking to contribute to good eating habits and supply the daily need for fibers and fluids, many times deficient in the context of today's modern lifestyle, that people are subject to, in the search for a better quality of life, this was idealized, studied and put in practice to achieve a process to obtain beverage enriched with vitamins and fibers with added fruit flavors and a beverage resulting from this process, object of the present patent.

In the market today, there are some functional foods that contain fibers and other necessary ingredients and substances for a good health, although none of them promote hydration and supply these substances at the same time. As examples, the known yogurts, containing fibers and other dairy-based foods, most of them with bacillus and bacteria beneficial to the body, and the others being solid foods, like granulated cookies and crackers or cereals which can be added liquids such as Milk, water and juices, normally used as appetite regulators.

Some of these foods have some disadvantages in the continuous use like the previous preparation before ingestion, the need to keep them cooled for ingestion as well as conservation, as well as the lack of the needed fluids day to day for a good hydration. The process to obtain a beverage enriched with vitamins and fibers with added fruit flavors and a beverage resulting from this process, object of this patent, result in a beverage that does not need refrigeration to preserve it, after opening as well as storage, due to its relatively long validity, enabling storage, it does not contain bacteria and/or bacillus, therefore not causing adverse reactions in the consumers.

There are some patent documents that describe functional foods and processes with fibers and other ingredients promoting the health of the human intestine, however none of them have the specific function of providing hydration, nutrition though vitamins and minerals, supplying food fibers in one product, and still easy storage, maintenance and intake, according to the object of this patent. Among these documents, the following can be cited:

The BR 0108534-4 application, SOLUBLE FIBER CONTAINING WATER, which describes a fluid similar to water containing safe water and a significant amount of soluble diet fiber, The resulting solution is usually transparent to the naked eye and has similar properties to potable water. The fluid has the intention of being a replacement to bottled water, or another mean to ensure appropriate hydration. Depending on the soluble fiber used, the fluid is non-caloric or it is extremely low in calories. The quantity of soluble fiber is adjusted for a specific amount of water, so that the adequate consumption of fluid ensures hydration (for example, eight glasses of 237 ml (8 ounces) a day) will also provide a good quantity of dietary fiber. This is particularly valuable in stressful situations when the diet cannot supply adequate fiber without supplement. The measured amount of fiber provided throughout the Day, is preferred over, and more convenient than administering in “bunches” of fiber through laxatives etc., in addition, the constant presence of soluble fibers in the digestive tract provide the known beneficial effects to moderate the increase of post-prandial blood glucose, modulation of the lipid levels in the serum and appetite suppression.

The BR 9916823-5 application, MIXTURE OF FIBERS FOR ENTERIC COMPOSITION, it is an enteric composition containing a source of proteins, a source of lipids, a source of carbohydrates and a mixture of fibers. The fiber mixture contains insulin and fructooligosacharides and has from 45 to 55% in mixture weight of soluble fibers and from 45 to 55% in mixture weight in insoluble fibers. The mixture of fibers can also contain the internal fibers of peas and the external casing of peas;

The BR 9915693-8 application, COMPOSITION CONTAINING SOY PROTEIN, DIET FIBER AND A PHYTOSTROGEN COMPOUND AND ITS USE IN THE PREVENTION AND/OR TREATMENT OF TYPE 2 DIABETES, THE METABOLIC SYNDROME AND CARDIOVASCULAR DISEASES, it is a composition containing (a) soy protein, (b) a phytoestrogen compound, and (c) diet fibers. The soy protein (a) is present in a quantity of at least 45 per cent in weight of the total protein levels of the composition, and such total protein level providing at least 15 per cent of the total energy level of the composition. The phytoestrogen compound (b) is preferably an isoflavin occurring naturally and is present in a quantity greater than 0.10 per cent in the soy protein's weight, and the diet fibers (c) are preferably soy fibers that are present in a quantity greater than 4 per cent in weight of the total weigh of the nutritional composition in a dry base. The composition is useful for the treatment of type 2 diabetes and cardiovascular diseases in a diabetic person;

The BR 9912627-3 application, COMPOSITION IN STABLE KIQUID SUSPENSION, AND PROCESSES FOR ITS PREPARATION AND USE AND ALSO WEIGHT AND CHOLESTEROL TREATMENT, the invention is regarding liquid composition containing chitosan, that remains stable and usable as an additive, for example, in water or aqueous solution (that is, water-based liquid);

The BR 9809046-1 application, NUTRITIONAL FORMULA CONTAINING HYDROLISATED PROTEIN AND A MIXTURE OF FIBERS, in which this invention is specifically directed to liquid nutritional formulas that contain hydrolisaded protein and/or amino acids and diet fiber. This invention supersedes the physical stability problems of the product and high viscosities through the use of non fermentable/soluble fibers, in combination with a mixture of non fermentable and soluble/insoluble fibers. The invention is also directed to the use of physiologically effective levels of fibers in nutritional products that use hydrolisated protein and/or free amino acids for the source of amino nitrogen to treat cramps, diarrhea, short intestine syndrome and other gastrointestinal diseases;

The BR 9806195-0 application, SOLUBLE EDULCORANT COMPOSITION CONTAINING FOOD FIBERS, ITS PREPARATION AND USE FOR INTAKE PURPOSES; a soluble edulcorant composition containing at least one gelatinous food fiber preferably soluble in mixture with other food fibers and one or more sweeteners preferably in a mixture among them, is here described;

The BR 9802202-4 application, FIBER-BASED NUTRITIONAL COMPOSITION, a fiber-base nutritional composition, comprising at least one mixture of internal pea fibers, fibers from the external casing of peas and insulin;

The BR 9801362-9 application, CRACKER ENRICHED WITH CHITOSAN, SOLUBLE FOOD FIBER; AND REDUCED LEVEL OF CALORY-FORMULATION AND PROCESSING METHODOLOGY, a cracker enriched with chitosan, soluble food fiber; and low calorie-formulation content and processing methodology. The use of a cracker characterized by elevated content of soluble food fiber and reduced level of calories is being proposed. For such, the processing formulation and methodology was posted in which the usual ingredients of the product are adequate to the intentional addition of chitosan, animal-origin soluble food fibers, as follows: wheat flour—100%; hydrogenated vegetal fat—10.0-14.0%; chitosan—4.0-6.0%; malt extract—1.5-3.0%; refined salt—1.0-2.0%; biological yeast—0.5-1.4%; protease (10 nu)—0.02-0.03%; soy lecithin—0.10-0.15%; sodium bicarbonate—0.45-0.65%; water—24.0-27.0%;

The BR 9714179-8 application, ABSORBABLE COMPOSITION CONTAINING PROPIONIC BACTERIA CAPABLE OF RELEASING NITROGEN MONOXIDE IN HUMAN OR ANIMAL DIGESTIVE TRACT, using propionic bacteria to obtain a common composition or an absorbable diet or medicinal composition, capable of releasing significant physiological quantities of nitrogen monoxide in the human or animal digestive tract;

The BR 9505807-9 application, METHOD TO DECREASE THE VISCOSITY OF AN AQUEOUS NUTRITIONAL COMPOSITION CONTAINING SOY FIBER AND NUTRITIONAL COMPOSITION, a method to decrease the viscosity in nutritional compositions containing soy fiber by adding acacia starch. The composition is in the preferred complete nutritive form and with the option of adding protein, non-fiber carbohydrate and other nutrients;

The BR 9306532-9 application, MIXTURE COMPOSITION FOR A BEVERAGE CONTAINING PSYLLIUM, mixture compositions for a beverage containing psyllium bark comprising divalent cation salt from strong inorganic acids selected from the group of magnesium sulphate, calcium sulphate, calcium chloride, zinc sulphate and zinc chloride and their mixtures; and many other national and international patents and applications like the U.S. Pat. No. 7,115,297, the U.S. Pat. No. 6,248,390 and MX PA 02008189.

Next reference is made to the figure attached to this descriptive report, for better understanding and depiction, where:

In FIG. 1 the fluxogram of the process to obtain a beverage enriched with fibers and vitamins with added fruit flavors and also a beverage from this process, object of this patent, highlighting all of the stages, from the beginning of the process to the distribution of the finalized product.

Then, it is described in a non-restrictive preferential form to perform the present process and the formulation of the obtained beverage, object of this patent, objective, without taking the object of this patent and the main formulation out of character; describing one of the possibilities that leads to accomplish the process, object described in the patent, in a way that it would work and the resulting product.

The process to obtain the beverage enriched with fibers and vitamins with added fruit flavors and a beverage from this process, object of the present patent, is a simple process, however specific and unique, possessing essentially 17 steps from the beginning of the mixture to its distribution to the consumer, the steps are as follows:

1—Place 50 to 70% of water in the tank;

2—Place 200 to 300 l of water in the mixture tank;

3—Add the soluble fiber by the tri-blender;

4—Send to the preparation tank;

5—Repeat the operation until the end of the fiber;

6—Place 200 to 300 l of water in the mixture tank;

7—Add the preservatives;

8—Send to the preparation tank;

9—Place 200 to 300 l of water in the mixture tank;

10—Add the fruit concentrate and send it to the preparation tank;

11—Add complementary water to adjust the final volume;

12—Send sample to the lab and wait for product approval in the quality control;

13—Pasteurize;

14—Send to the storage tank;

15—Bottling and packaging of the final beverage;

16—Palleting and storage;

17—Distribution.

The process to obtain a beverage enriched with fibers and vitamins with added fruit flavors and a beverage from this process, object of the present patent, has as result a beverage functional for hydration, providing up to 20% of the necessary fiber to the human body, improving intestinal function, contributing to a good quality of life, containing the following composition, presented on Table 1, as follows:

TABLE 1

| Components | Percentage |
|---|---|
| Concentrated fruit juice 65 to 80° brix | 0.25 to 0.3% |
| Soluble fiber | 2.2 to 3.1% |
| Preservers (Potassium sorbate and sodium | 0.01 to 0.03% |
| benzoate) | |
| Tropical fruit aroma and others (pineapple | 0.003 to 0.06% |
| and mint, pomegranate, Orange, lime, | |
| passion fruit, papaya, peaches, cajá | |
| (hog-plum), mango, strawberry). | |
| Citric Acid | 0.1 to 0.3% |
| Niacin | 0.001 to 0.002% |
| Folic Acid | 0.000010 to 0.000020% |
| Water | 95 to 99% |
| Sweetener (aspartame or sodium | 0.003 to 0.004% |
| saccharin or similar) | |
| Acesulfame potassium | 0.003 to 0.004% |
| Pantothenic acid | 0.00032 to 0.00042% |
| Pyridoxine | 0.000095 to 0.000100% |

Therefore, the process to obtain a beverage enriched with fibers and vitamins with added fruit flavors and a beverage from this process, object of the present patent, as described above, presenting a sequence of fabrication steps and unique compositions, configuring great advantages in relation to the known processes and beverages currently found in the market in this business. Among these advantages it can be named: easy consumption, storage and keeping, since it does not need refrigeration and the advantage of providing hydration and supplying the necessary elements to good eating habits and human health, like fibers, vitamins and minerals.

Thus, by the characteristics of format, sequence, formulation and functioning, in the process as well as the product obtained, according to the described above, it can be clearly noticed that the PROCESS TO OBTAIN A BEVERAGE ENRICHED WITH FIBERS AND VITAMINS WITH ADDED FRUIT FLAVORS AND A BEVERAGE FROM THIS PROCESS, it is a new object for the State of Technique in which is full of unseen innovation conditions, inventive activity and industrialization, that deems the Privileged of Patent of Invention.

1- PROCESS TO OBTAIN A BEVERAGE ENRICHED WITH FIBERS AND VITAMINS WITH ADDED FRUIT FLAVORS AND A BEVERAGE FROM THIS PROCESS, process to obtain a beverage characterized by having essentially 17 steps from the beginning of the mixture to its distribution to the consumer, being the stages as follows: 1—Place 50 to 70% of water in the tank; 2—Place 200 to 300 l of water in the mixture tank; 3—Add the soluble fiber by the tri-blender; 4—Send to the preparation tank; 5—Repeat the operation until the end of the fiber; 6—Place 200 to 300 l of water in the mixture tank; 7—Add the preservatives; 8—Send to the preparation tank; 9—Place 200 to 300 l of water in the mixture tank; 10—Add the fruit concentrate and send it to preparation tank; 11—Add complementary water to adjust the final volume of water; 12—Send the sample to the lab and wait for the product's approval; 13—Pasteurize; 14—send to the storage tank; 15—Bottle and send to package final beverage; 16—Palleting and Storage; 17—Distribution of the final product.

2- PROCESS TO OBTAIN A BEVERAGE ENRICHED WITH FIBERS AND VITAMINS WITH ADDED FRUIT FLAVORS AND A BEVERAGE FROM THIS PROCESS, beverage obtained according to claim 1, characterized by containing the following components and corresponding percentages, being those: Concentrated fruit juices 65 to 80° brix, from 0.25 to 0.3%; Soluble fiber from 2.2 to 3.1%; Preservatives (Potassium sorbate and Sodium benzoate) from 0.01 to 0.03%; Tropical fruits aroma and others (pineapple and mint, pomegranate, orange, lime, passion fruit, papaya, peach, cajá (hog-plum), mango, strawberry; from 0.003 to 0.06%; Citric acid from 0.1 to 0.3%; Niacin from 0.001 to 0.002%; Folic acid from 0.000010 to 0.000020%; Water from 95 to 99%; Sweetener (aspartame or sodium saccharin or similar) from 0.003 to 0.004%; Acessulfame potassium from 0.003 to 0.004%; Pantothenic acid from 0.00032 to 0.00042%; Pyridoxine from 0.000095 to 0.000100%.
